(19) United States
(12) Patent Application Publication
(10) Pub. No.: US 2011/0102389 A1
(43) Pub. Date: May 5, 2011

(54) DISPLAY APPARATUS

(75) Inventors: Kyung-ho PARK, Cheonan-si (KR); Si Hyun AHN, Cheonan-si (KR); So-Young KIM, Jeju-si (KR)

(73) Assignee: SAMSUNG ELECTRONICS CO., LTD., Suwon-si (KR)

(21) Appl. No.: 12/783,991

(22) Filed: May 20, 2010

(30) Foreign Application Priority Data
Nov. 5, 2009 (KR) 10-2009-0106625

(51) Int. Cl. G09G 5/00

(52) U.S. Cl. 345/205

(57) ABSTRACT

A display apparatus includes; a display panel which includes a plurality of pixels which receive a data signal to display an image, a plurality of sensors disposed within the display panel, wherein the plurality of sensors sense an external signal from an exterior of the display apparatus and output a sensing signal corresponding to the external signal, a data driver which provides the data signal to the plurality of pixels, a gate driver which outputs a plurality of gate signals to the plurality of pixels, and a sensor driver which includes a plurality of stages which output a plurality of sensor scan signals to the plurality of sensors, wherein the sensor driver sequentially drives the plurality of stages in a first scan mode and divides the plurality of stages into two groups of stages and alternately drives the two groups of stages in subsequent frames in a second scan mode.

This application claims priority to Korean Patent Application No. 2009-106625, filed on Nov. 5, 2009, and all the benefits accruing therefrom under 35 U.S.C. §119, the content of which in its entirety is herein incorporated by reference.

### BACKGROUND OF THE INVENTION

1. Field of the Invention

The present invention relates to a display apparatus. More particularly, the present invention relates to a display apparatus having sensors located within a display panel.

2. Description of the Related Art

Recently, as display apparatuses have come into widespread use, such display apparatus have been widely applied in various fields. Besides its displaying function, other functions such as a touch screen and an optical communication function have been added to the display apparatus.

In order to perform a touch screen function, the typical touch screen display apparatus is utilizes sensors that receive light and output sensing signals corresponding to the light received thereby. However, if the sensors are arranged in a separate panel from a display panel, e.g., a separate touch sensing panel, optical characteristics of the display apparatus are deteriorated and its thickness undesirably increases. Thus, recent efforts have been made to develop a display apparatus that has the sensors built into the display panel itself.

### BRIEF SUMMARY OF THE INVENTION

Exemplary embodiments of the present invention provide a display apparatus capable of changing a scan mode of a sensor disposed within a display panel.

According to the exemplary embodiments, a display apparatus includes: a display panel which includes a plurality of pixels which receive a data signal to display an image, a plurality of sensors disposed within the display panel, wherein the plurality of sensors sense an external signal from an exterior of the display apparatus and output a sensing signal corresponding to the external signal, a data driver which provides the data signal to the plurality of pixels, a gate driver which outputs a plurality of gate signals to the plurality of pixels, and a sensor driver which includes a plurality of stages which output a plurality of sensor scan signals to the plurality of sensors, wherein the sensor driver sequentially drives the plurality of stages in a first scan mode, and divides the plurality of stages into two groups of stages and alternately drives the two groups of stages in subsequent frames in a second scan mode.

In one exemplary embodiment, the display panel includes an array substrate on which a plurality of pixels which receive a data signal is arranged and an opposite substrate facing the array substrate and coupled with the array substrate. In one exemplary embodiment, the sensors are disposed within the display panel to sense an external signal and output a sensing signal corresponding to the external signal. In one exemplary embodiment, the data driver provides the data signal to the plurality of pixels, and the gate driver outputs a plurality of gate signals to the plurality of pixels.

In one exemplary embodiment, the sensor driver includes a plurality of stages which output a plurality of scan signals to the plurality of sensors. In one exemplary embodiment, the sensor driver sequentially drives the plurality of stages in a first scan mode, and the sensor driver divides the plurality of stages into two groups and alternately drives the two groups of stages in a second scan mode.

According to another exemplary embodiment, a display apparatus includes; a display panel including an array substrate on which a plurality of pixels which receive an image signal is arranged and an opposite substrate coupled with the array substrate, a plurality of sensors disposed within the display panel, wherein the plurality of sensors sense an external signal and output a sensing signal corresponding to the external signal, a data driver which provides the image signal to the plurality of pixels, a gate driver which outputs a plurality of gate signals to the plurality of pixels, a first sensor driver including a plurality of first stages which are operated in a first scan mode and sequentially output a plurality of first scan signals to the plurality of sensors, and a second sensor driver including a plurality of second stages, wherein the plurality of second stages are divided into two groups which are alternately operated in subsequent frames in a second scan mode, and wherein the plurality of second stages output a plurality of second scan signals through each of the two groups to the plurality of sensors.

Accordingly, a timing controller controls a rising timing of a first start signal and a second start signal, thereby driving the sensor driver that scans the sensors built in the display panel in either a progress scan method or an interlace scan method.

### BRIEF DESCRIPTION OF THE DRAWINGS

The above and other advantages of the present invention will become readily apparent by reference to the following detailed description when considered in conjunction with the accompanying drawings wherein:

FIG. 1 is a block diagram showing an exemplary embodiment of a display apparatus according to the present invention;

FIG. 2 is a block diagram showing an exemplary embodiment of a sensor driver of FIG. 1;

FIG. 3 is a timing diagram showing an exemplary embodiment of a sensor driver driven in a first scan mode;

FIG. 4 is a timing diagram showing an exemplary embodiment of a sensor driver driven in a second scan mode;

FIG. 5 is a block diagram showing another exemplary embodiment of a sensor driver according to the present invention;

FIG. 6 is a timing diagram showing another exemplary embodiment of a sensor driver driven in a first scan mode;

FIG. 7 is a timing diagram showing another exemplary embodiment of a sensor driver driven in a second scan mode;

FIG. 8 is a block diagram showing another exemplary embodiment of a sensor driver according the present invention;

FIG. 9 is a timing diagram showing another exemplary embodiment of a first sensor driver of FIG. 8;

FIG. 10 is a top plan view showing an exemplary embodiment of a display apparatus of FIG. 1; and

FIG. 11 is a cross-sectional view showing an exemplary embodiment of a display panel of FIG. 10.

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

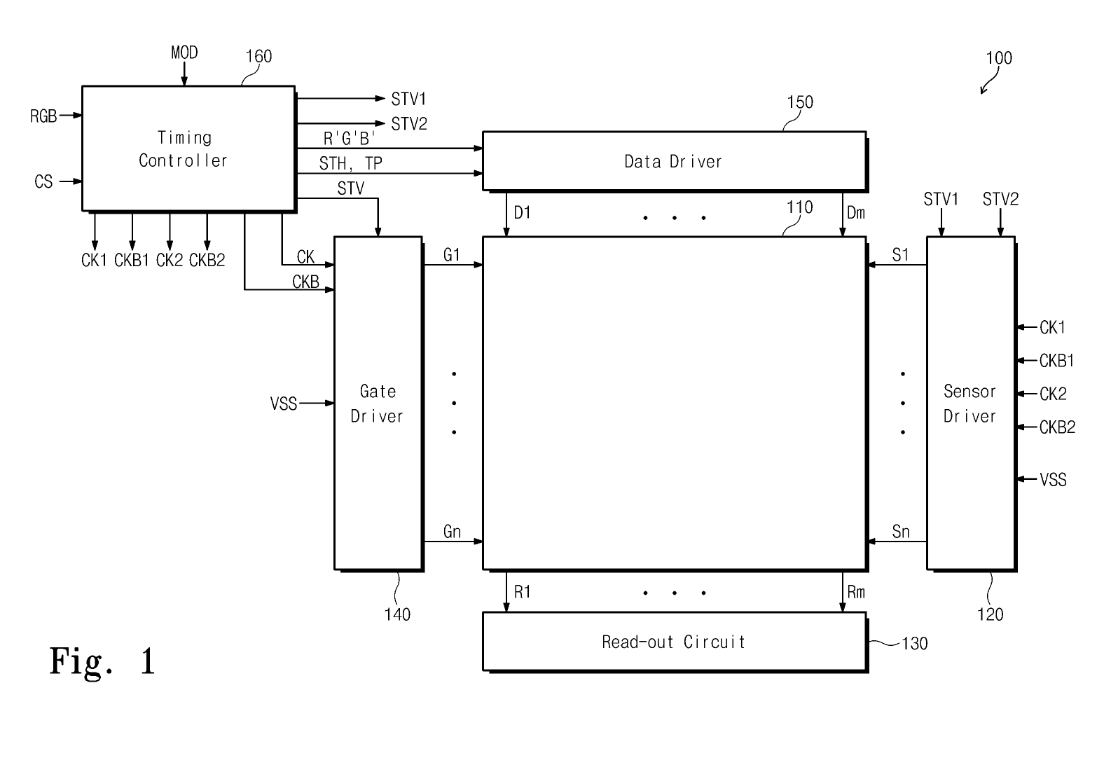

FIG. 1 is a block diagram showing an exemplary embodiment of a display apparatus according to the present invention.

Referring to FIG. 1, a display apparatus 100 includes a timing controller 160, a data driver 150, a gate driver 140, a read-out circuit 130, a sensor driver 120 and a display panel 110.

The display panel 110 includes a plurality of pixels and a plurality of sensors. That is, the pixels and the sensors are disposed within the display panel 110 itself, and no separate sensor panel is provided. The display panel 110 includes two substrates facing each other, and the pixels and the sensors may be arranged on one, or both, of the two substrates. For example, in one exemplary embodiment wherein the pixels are arranged on one substrate of the two substrates, the sensors may be arranged on the other substrate of the two substrates.

Each pixel is connected to the data driver 150 and the gate driver 140. Therefore, each pixel is turned on in response to a gate signal provided from the gate driver 140 to display an image corresponding to a data voltage provided from the data driver 150. In one exemplary embodiment, each pixel is connected to one or more pixel electrodes.

Each sensor senses an external signal from an exterior and outputs a sensing signal in response to the sensed external signal. Exemplary embodiments of the external signal may include, light, pressure, etc. Each sensor is connected to the sensor driver 120 and the read-out circuit 130. Thus, each sensor is turned on in response to a sensor scan signal provided from the sensor driver 120 to provide the sensing signal to the read-out circuit 130.

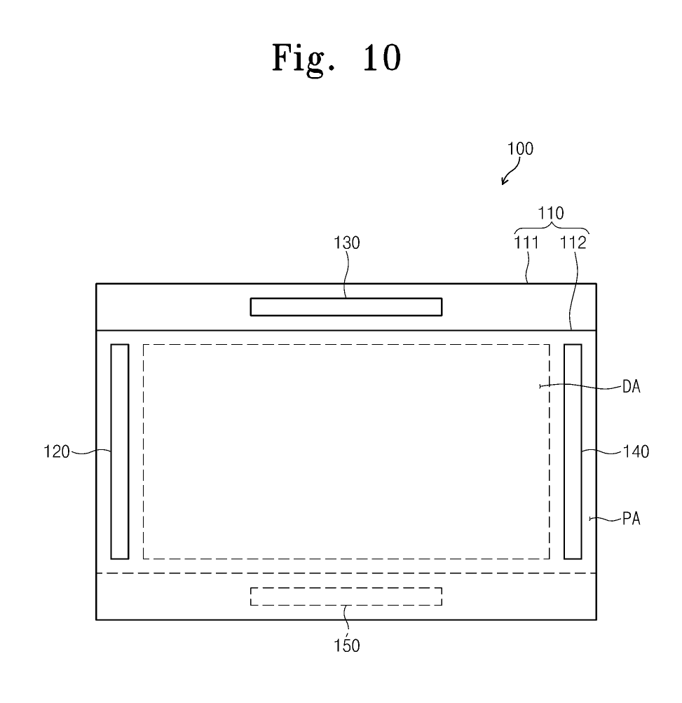

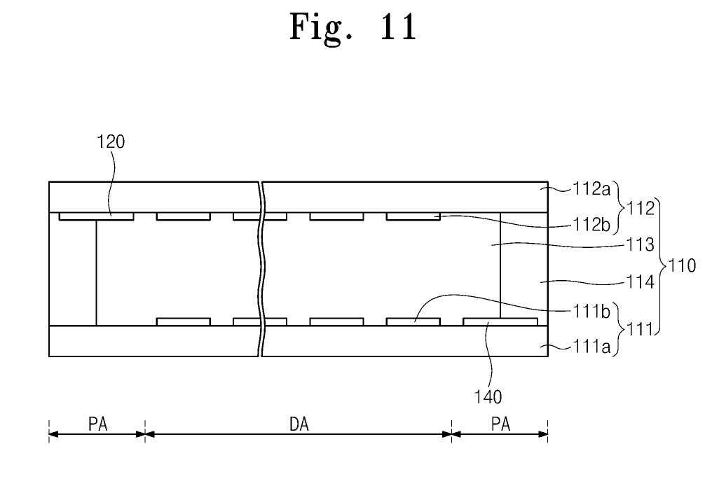

More detailed descriptions of a structure of the display panel 110 will described with reference to FIGS. 10 and 11 below.

The timing controller 160 receives a plurality of image signals RGB and a plurality of control signals CS from outside of the display apparatus 100 in order to display the image. Although the image signals RGB may correspond to a color image, alternative embodiments include configurations wherein the image signals RGB may correspond to a monochromatic image. The timing controller 160 converts a data format of the image signals RGB into a data format appropriate to an interface between the timing controller 160 and the data driver 150 and provides the converted image signals R′G′B′ to the data driver 150. In addition, the timing controller 160 provides a data control signal, for example, an output start signal TP and a horizontal start signal STH, to the data driver 150 and gate control signals, such as a vertical start signal STV, vertical clock signal CK, and a vertical clock bar signal CKB, to the gate driver 140.

The gate driver 140 sequentially outputs gate signals G1˜Gn in response to the gate control signals STV, CK and CKB provided from the timing controller 160. As a result, the pixels may be scanned in sequence one row at a time by the gate signals G1˜Gn. Specifically, the gate signals G1˜Gn are sequentially applied to gate lines on the display panel 110 to prepare the pixels connected to those gate lines to receive a data voltage D1˜Dm as described below.

The data driver 150 converts the image signals R′G′B′ to data voltages D1˜Dm in response to the data control signal TP and STH provided from the timing controller 160 to output the data voltages D1˜Dm. The output data voltages D1˜Dm are applied to the display panel 110 such that each pixel row receives a set of data voltages D1˜Dm, sequentially.

Consequently, each pixel is turned on in response to a corresponding gate signal among the gate signals G1˜Gn, and the turned-on pixel receives a corresponding data voltage from the data driver 150 to display the image having a desired gray-scale.

Meanwhile, the timing controller 160 outputs a first start signal STV1, a second start signal STV2, a first clock signal CK1, a second clock signal CK2, a first clock bar signal CKB1 and a second clock bar signal CKB2 to drive the sensor driver 120. The timing controller 160 may provide the vertical clock signal CK and the vertical clock bar signal CKB, which are provided to the gate driver 140, to the sensor driver 120 as the first clock signal CK1 and the first clock bar signal CKB1, respectively. Specifically, the sensor driver 120 receives the vertical clock signal CK as the first clock signal CK1 and the vertical clock bar signal CKB as the first clock bar signal CKB1.

Also, the sensor driver 120 may be driven in either of a first scan mode or a second scan mode in accordance with an operation method thereof That is, in the first scan mode, the sensor driver 120 is driven in a progressive scan method to operate the sensors of the display panel 110 one row at a time. In the second scan mode, the sensor driver 120 is driven in an interlace scan method to operate odd rows of the sensors in odd frames and even rows of the sensors in even frames. Although the present exemplary embodiment is described having the second scan mode of the sensor driver 120 operate odd rows of the sensors in odd frames and even rows of the sensors in even frames, the present invention is not limited thereto and alternative exemplary embodiments may include configurations wherein the second scan mode of the sensor driver 120 operates even rows of the sensors in odd frames and odd rows of the sensors in even frames.

A mode selection signal MOD provided to the timing controller 160 determines whether the sensor driver 120 is driven either in the first scan mode or in the second scan mode. The mode selection signal MOD may be changed by a user or may be preset into a value corresponding to the first scan mode or the second scan mode.

The timing controller 160 controls a start timing of the first start signal STV1 and the second start signal STV2 in response to the mode selection signal MOD. In other words, in an exemplary embodiment wherein the first scan mode is selected, the timing controller 160 generates a second start signal STV2 that is delayed by one clock period to be later than the first start signal STV1. Alternatively, in an exemplary embodiment wherein the second scan mode is selected, the timing controller 160 generates a second start signal STV2 that is delayed by one frame period to be later than the first start signal STV1.

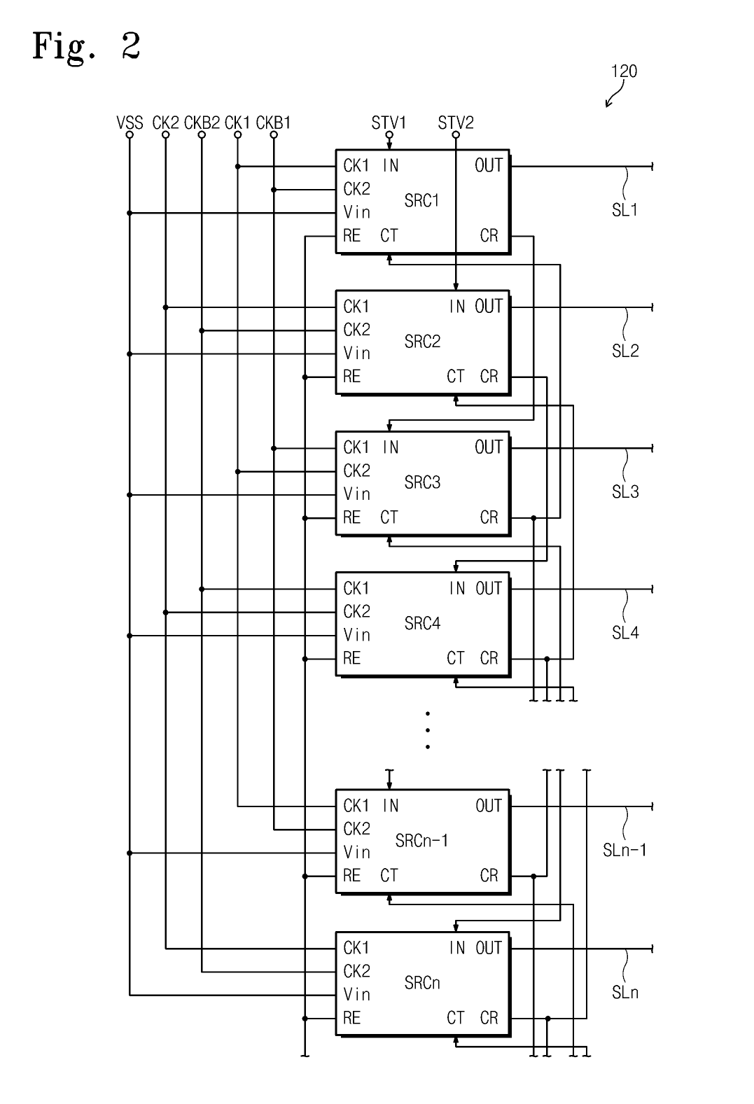

The sensor driver 120 may be driven either in the first scan mode or in the second scan mode in response to the first start signal STV1 and the second start signal STV2. The sensor driver 120 sequentially provides scan signals S1˜Sn to the display panel 110. Detailed descriptions of the sensor driver 120 will be described with reference to FIGS. 2 to 9 below.

The sensors sense the externally supplied signal, e.g., light, pressure, etc., to generate the sensing signals R1˜Rm corresponding to the externally supplied signal and provide the sensing signals R1˜Rm to the read-out circuit 130 in response to the scan signals S1˜Sn. The sensing signals R1˜Rm are processed by the read-out circuit 130.

FIG. 2 is a block diagram showing an exemplary embodiment of the sensor driver 120 of FIG. 1.

Referring to FIG. 2, the sensor driver 120 includes a plurality of stages SRC1˜SRCn.

If the first scan mode is selected, the sensor driver 120 drives all of the stages SRC1˜SRCn in one frame period to sequentially output the scan signals S1˜Sn to the display panel 110. Meanwhile, if the second scan mode is selected, the stages SRC1˜SRCn are divided into two groups and the two groups of the stages SRC1˜SRCn are alternately driven in sequential frame periods. That is, a first group of the stages includes odd stages SRC1, SRC3, . . . , SRCn-1 and a second group of the stages includes even stages SRC2, SRC4, . . . , SRCn. The two groups of the stages SRC1˜SRCn are alternately driven in two frame units. Thus, if the odd stages SRC1, SRC3, . . . , SRCn-1 are driven in a q-th frame, the even stages SRC2, SRC4, . . . , SRCn are driven in a subsequent (q+1)-th frame.

Each of the stages SRC1˜SRCn includes an input terminal IN, a first clock terminal CK1, a second clock terminal CK2, a control terminal CT, a voltage input terminal Vin, a reset terminal RE, an output terminal OUT and a carry terminal CR.

The odd stages SRC1, SRC3, . . . , SRCn-1 among the stages SRC1˜SRCn receive the first clock signal CK1, the first clock bar signal CKB1 and a ground voltage VSS. The first odd stage SRC1 also receives the first start signal STV1. The even stages SRC2, SRC4, . . . , SRCn receive the second clock signal CK2, the second clock bar signal CKB2 and the ground voltage VSS. The first even stage SRC2 also receives the second start signal STV2.

The first clock signal CK1 has a phase opposite to the first clock bar signal CKB1 and the second clock signal CK2 has a phase opposite to the second clock bar signal CKB2. In addition, the second clock signal CK2 has a phase that is delayed by one fourth of one time period T after the first clock signal CK1.

A first clock terminal CK1 of a first odd stage SRC1 among the odd stages SRC1, SRC3, . . . , SRCn-1 receives the first clock signal CK1, and a second clock terminal CK2 of the first odd stage SRC1 receives the first clock bar signal CKB1. An input terminal IN of the first odd stage SRC1 receives the first start signal STV1, and a control terminal CT of the first odd stage SRC1 receives a carry signal of a second odd stage SRC3. In addition, an output terminal OUT of the first odd stage SRC1 is connected to a corresponding scan line SL1, and a carry terminal CR of the first odd stage SRC1 is connected to an input terminal IN of the second odd stage SRC3. The sensor scan line SL1 is arranged in the display panel 110 to apply the scan signal to a corresponding sensor among the plurality of sensors.

The second odd stage SRC3 has substantially the same structure and function as those of the first odd stage SRC1 except that a first clock terminal CK1 of the second odd stage SRC3 receives the first clock bar signal SKB1, a second clock terminal CK2 of the second odd stage SRC3 receives the first clock signal CK1, and the input terminal IN of the second odd stage SRC3 receives a carry signal of a previous odd stage, e.g., the first odd stage SRC1.

That is, a first clock terminal CK1 of a (4k-3)-th stage among the stages SRC1˜SRCn (wherein k is an integer which is equal to or larger than 1) receives the first clock signal CK1, and a second clock terminal CK2 of the (4k-3)-th stage receives the first clock bar signal CKB1. Also, a first clock terminal CK1 of a (4k-1)-th stage among the stages SRC1˜SRCn receives the first clock bar signal CKB1, and a second clock terminal CK2 of the (4k-1)-th stage receives the first clock signal CK1.

Meanwhile, a first clock terminal CK1 of a first even stage SRC2 among the even stages SRC2, SRC4, . . . , SRCn receives the second clock signal CK2, and a second clock terminal CK2 of the first even stage SRC2 receives the second clock bar signal CKB2. An input terminal IN of the first even stage SRC2 receives the second start signal STV2, and a control terminal CT of the first even stage SRC2 receives a carry signal of a second even stage SRC4. In addition, an output terminal OUT of the first even stage SRC2 is connected to a corresponding scan line SL2, and a carry terminal CR of the first even stage SRC2 is connected to an input terminal IN of the second even stage SRC4.

The second even stage SRC4 has substantially the same structure and function as those of the first even stage SRC2 except that a first clock terminal CK1 of the second even stage SRC4 receives the second clock bar signal CKB2, a second clock terminal CK2 of the second even stage SRC4 receives the second clock signal CK2, and the input terminal IN of the second even stage SRC4 receives a carry signal of a previous even stage, e.g., the first even stage SRC2.

That is, a first clock terminal CK1 of a (4k-2)-th stage among the stages SRC1˜SRCn receives the second clock signal CK2, and a second clock terminal CK2 of the (4k-2)-th stage receives the second clock bar signal CKB2. Also, a first clock terminal CK1 of a 4k-th stage among the stages SRC1˜SRCn receives the second clock bar signal CKB2, and a second clock terminal CK2 of the 4k-th stage receives the second clock signal CK2.

The ground voltage VSS is applied to the voltage input terminal Vin of each of the stages SRC1˜SRCn, and a reset signal is applied to the reset terminal RE of each of the stages SRC1˜SRCn. In one exemplary embodiment, the reset signal may be provided from outside of the sensor driver 120. In another exemplary embodiment a signal generated from the sensor driver 120 may be used as the reset signal.

Although not shown in FIG. 2, the sensor driver 120 may further include two dummy stages after an n-th stage SRCn to provide the carry signal to a control terminal CT of an (n-1)-th stage SRCn-1 and the n-th stage SRCn. In the exemplary embodiment wherein the sensor driver 120 further includes the two dummy stages, a carry signal of last dummy stage may be applied to the stages SRC1˜SRCn as the reset signal.

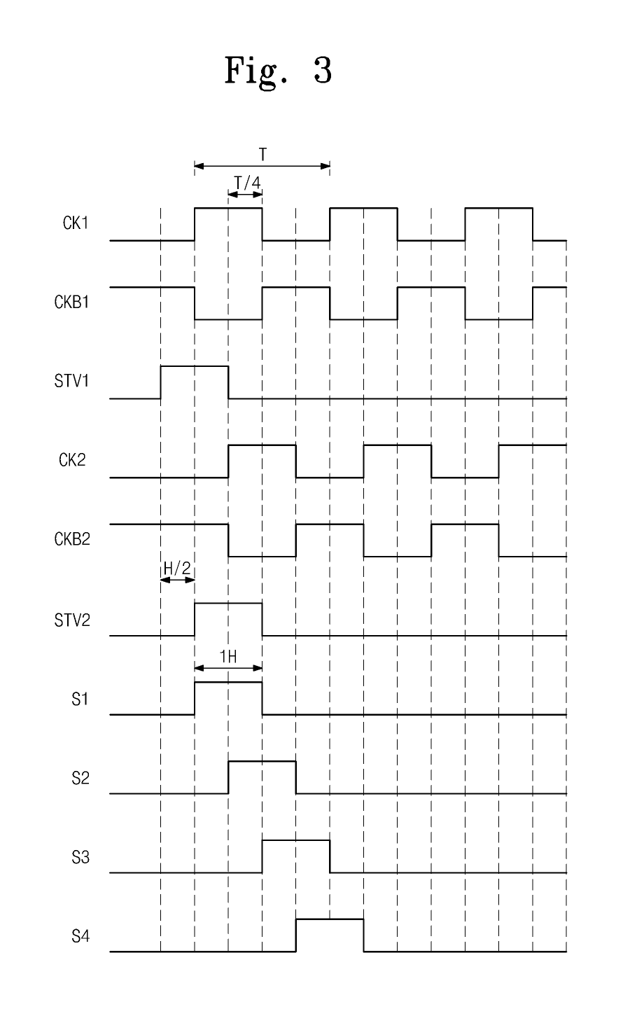

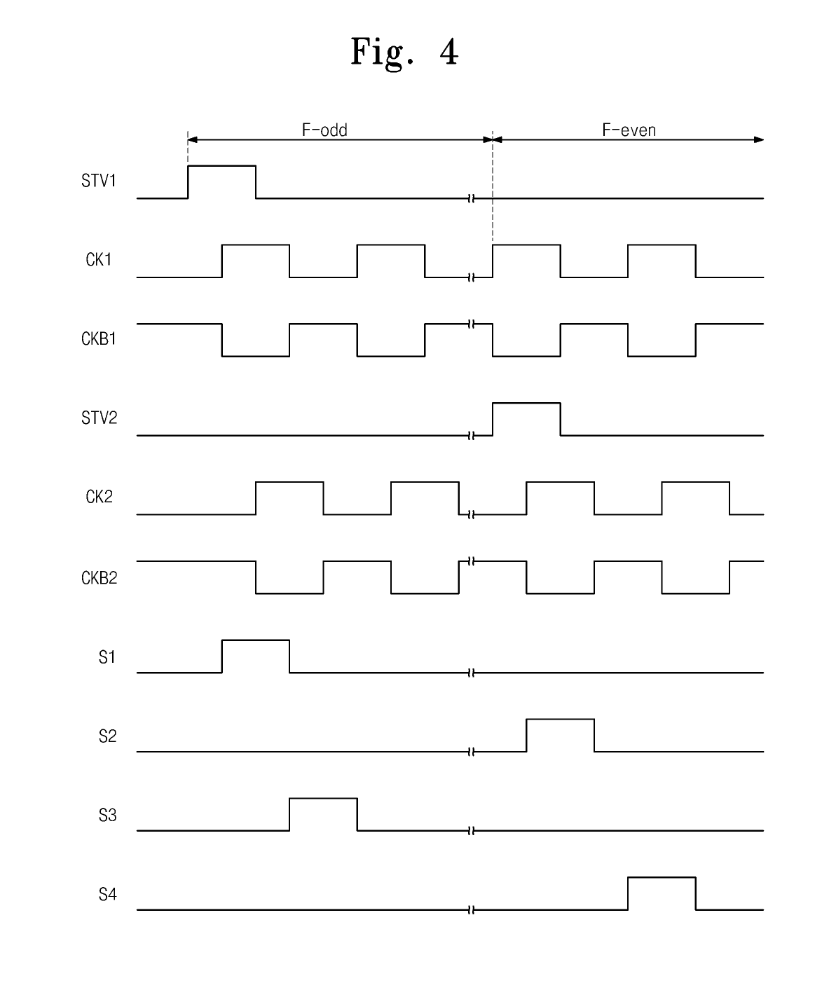

Hereinafter, an operation of the sensor driver will be described with reference to FIGS. 3 and 4.

FIG. 3 is a timing diagram showing an exemplary embodiment of the sensor driver driven in the first scan mode, and FIG. 4 is a timing diagram showing an exemplary embodiment of the sensor driver driven in the second scan mode.

Referring to FIG. 3, the sensor driver 120 is driven in the progressive scan method in the first scan mode. Thus, the sensor driver 120 receives the first start signal STV1 generated at a logic high state, e.g., an “on state” in one horizontal scan period (hereinafter, referred to as “1H period”) and the second start signal STV2 that is delayed by a H/2 period to be later than the first start signal STV1 from the timing controller 160.

After the first start signal STV1 is generated, the first odd stage SRC1 outputs a first scan signal 51 to a first scan line SL1 during a high period of the first clock signal CK1. Then, when the second start signal STV2 is generated, the first even stage SRC2 outputs a second scan signal S2 to a second scan line SL2 during a high period of the second clock signal CK2. Thus, the first scan signal 51 and the second scan signal S2 are overlapped with each other by H/2 period.

In addition, the second odd stage SRC3 outputs a third scan signal S3 to a third scan line SL3 during a high period of the first clock bar signal CKB1, and the second even stage SRC4 outputs a fourth scan signal S4 to a fourth scan line SL4 during a high period of the second clock bar signal CKB2.

Therefore, as shown in FIG. 3, the first to fourth scan signals S1˜S4 may be sequentially applied to the first to fourth scan lines SL1˜SL4 in the first scan mode. Remaining scan lines may be sequentially operated in a process similar to that described above.

Referring to FIG. 4, the sensor driver 120 is driven in the interlace scan method during the second scan mode. Thus, the sensor driver 120 receives the first start signal STV1 and the second start signal STV2 that is delayed by one frame period to be later than the first start signal STV1 from the timing controller 160. This is different from the previously described progressive scan method wherein the second start signal STV2 was delayed from the first start signal STV1 by only one half a horizontal scan period H/2.

In odd frames F-odd, when the first start signal STV1 is generated, the first odd stage SRC1 outputs the first scan signal S1 to the first scan line SL1 during the high period of the first clock signal CK1. Then, the second odd stage SRC3 outputs the third scan signal S3 to the third scan line SL3 during the high period of the first clock bar signal CKB1. Although not shown in FIG. 4, remaining odd scan lines are sequentially operated in the odd frames F-odd.

Since only the odd scan lines SL1 and SL3 are operated in the odd frames F-odd, scan signals generated during the odd frames F-odd are not overlapped with each other, e.g., each signal is one horizontal scan period H in duration and each subsequent scan signal begins when the previous scan signal ends.

The second start signal STV2 is generated when the odd frames F-odd are finished. The even frames F-even start in accordance with the application of the second start signal STV2, and the first even stage SRC2 outputs the second scan signal S2 to the second scan line SL2 during the high period of the second clock signal CK2. Then, the second even stage SRC4 outputs the fourth scan signal S4 to the fourth scan line SL4 during the high period of the second clock bar signal CKB2. Although not shown in FIG. 4, remaining even scan lines are sequentially operated in the even frames F-even.

Since only the even scan lines SL2 and SL4 are operated in the even frames F-even, scan signals generated during the even frames F-even are not overlapped with each other, e.g., each signal is one horizontal scan period H in duration and each subsequent scan signal begins when the previous scan signal ends.

As described above, the sensor driver 120 may be driven either in the progressive scan method or the interlace scan method by controlling the timing of the high period of the first and second start signals STV1 and STV2.

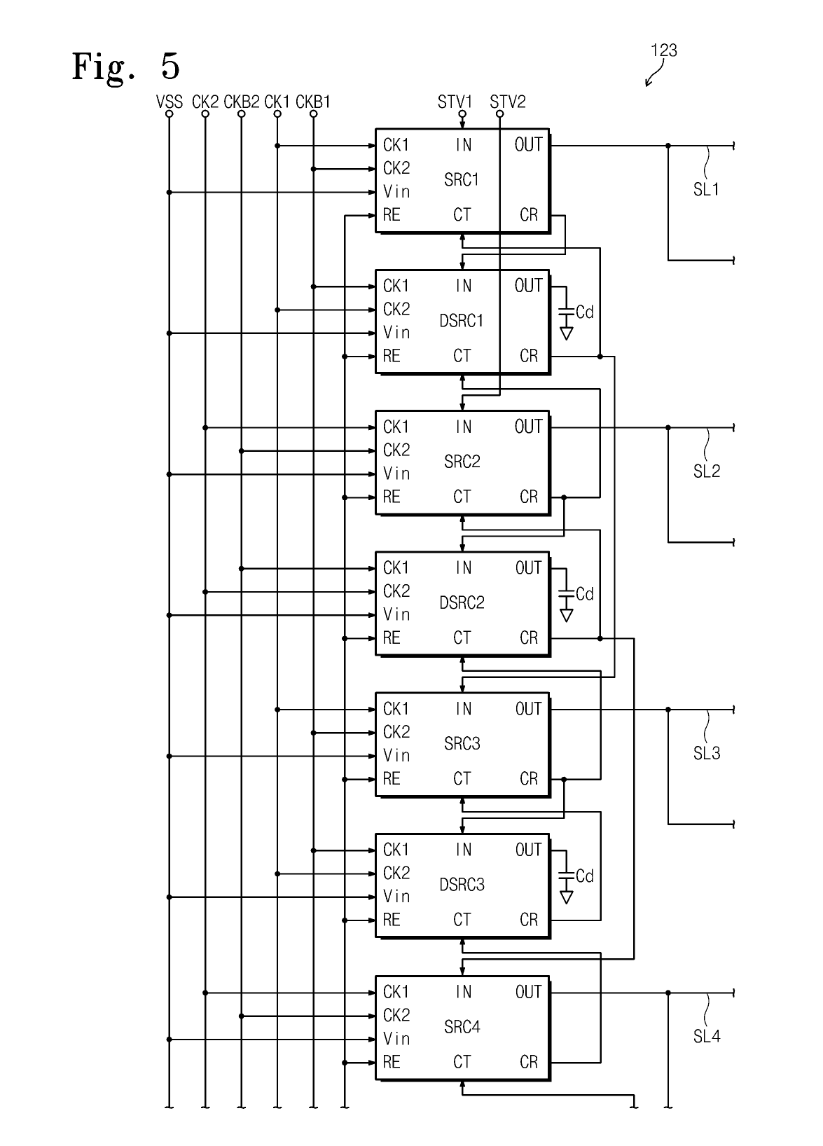

FIG. 5 is a block diagram showing another exemplary embodiment of a sensor driver according to the present invention.

Referring to FIG. 5, a sensor driver 123 includes a plurality of stages SRC1˜SRC4 and a plurality of dummy stages DSRC1˜DSRC4. In FIG. 5, only four stages and four dummy stages of the exemplary embodiment of a sensor driver 123 have been illustrated for the convenience of explanation, however, the number of the stages and the number of the dummy stages in the sensor driver 123 should not be limited thereto or thereby.

Each of the dummy stages DSRC1˜DSRC4 is arranged between subsequent stages of the functional stages SRC1˜SRC4. More particularly, a first dummy stage DSRC1 is arranged between a first stage SRC1 and a second stage SRC2, a second dummy stage DSRC2 is arranged between the second stage SRC2 and a third stage SRC3, etc.

An output terminal OUT of each of the stages SRC1˜SRC4 is arranged in a one-to-one correspondence with a plurality of scan lines SL1˜SL4 that is arranged on the display panel 110 (shown in FIG. 1). In the present exemplary embodiment, each of the scan lines SL1˜SL4 may include two sub-scan lines that are substantially parallel to each other.

The dummy stages DSRC1˜DSRC4 are not connected to the scan lines SL1˜SL4 arranged in the display panel 110. That is, each of the dummy stages DSRC1˜DSRC4 provides a carry signal to a corresponding stage of the stages SRC1˜SRC4, but is not connected to the scan lines SL1˜SL4. However, an output terminal OUT of each of the dummy stages DSRC1˜DSRC4 may be connected to a dummy capacitor Cd with a size corresponding to a load connected to each scan line in order to mimic the electrical load effects of the scan line on the stages SRC1˜SRC4. Thus, the dummy stages DSRC1˜DSRC4 may be driven under the same operating conditions as the stages SRC1˜SRC4.

First clock terminals CK1 of odd stages SRC1 and SRC3 among the stages SRC1˜SRC4 receive a first clock signal CK1 and second clock terminals CK2 of the odd stages SRC1 and SRC3 receive a first clock bar signal CKB1. Also, first clock terminals CK1 of even stages SRC2 and SRC4 receive a second clock signal CK2 and second clock terminals CK2 of the even stages SRC2 and SRC4 receive a second clock bar signal CKB2.

On the contrary, first clock terminals CK1 of odd dummy stages DSRC1 and DSRC3 among the dummy stages DSRC1˜DSRC4 receive the first clock bar signal CKB1 and second clock terminals CK2 of the odd dummy stages DSRC1 and DSRC3 receive the first clock signal CK1. Also, first clock terminals CK1 of even dummy stages DSRC2 and DSRC4 receive the second clock bar signal CKB2 and second clock terminals CK2 of the even dummy states DSRC2 and DSRC4 receive the second clock signal CK2.

A control terminal CT of each stage SRC1˜SRC4 receives a carry signal through a carry terminal CR of a subsequent dummy stage, and, except for the first odd stage SRC1 and the first even stage SRC2, an input terminal IN of each stage SRC1˜SRC4 is connected to a carry terminal CR of a previous odd or even dummy stage, depending upon whether the stage is even or odd. That is, a carry signal of a q-th dummy stage (wherein q is an integer which is equal to or larger than 1) is provided to an input terminal IN of a (q+2)-th stage, and a carry signal of the q-th stage is provided to the q-th dummy stage.

Exceptionally, as described briefly above, an input terminal IN of a first stage SRC1 among the stages SRC1˜SRC4 receives a first start signal STV1, and an input terminal IN of a second stage SRC2 among the stages SRC1˜SRC4 receives a second start signal STV2.

Also, a control terminal CT of each dummy stage DSRC1˜DSRC4 receives the carry signal through a carry terminal CR of a subsequent stage, and an input terminal IN of each dummy stage DSRC1˜DSRC4 receives the carry signal corresponding to a carry terminal CR of a previous stage.

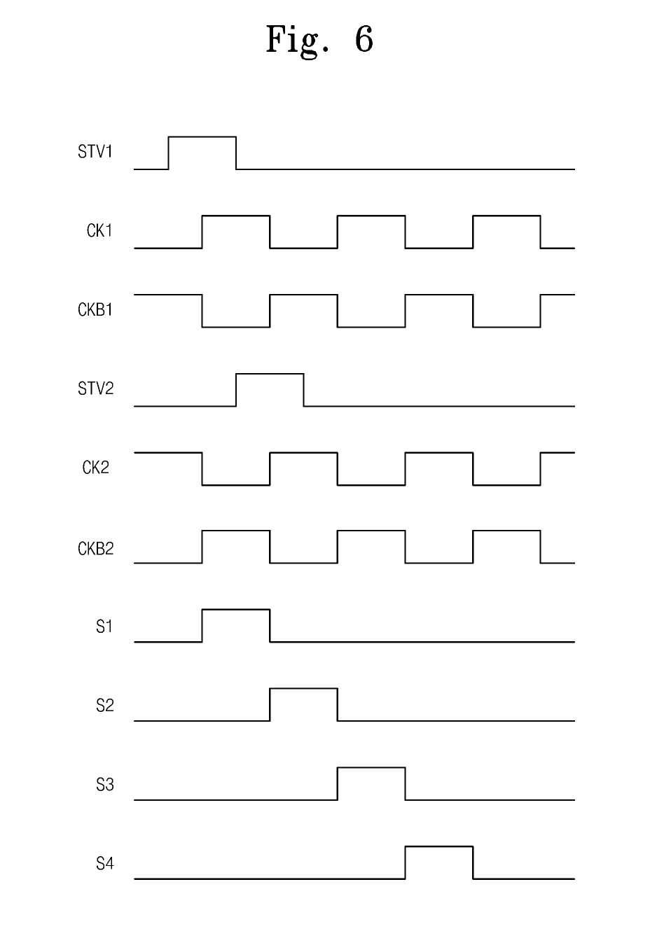

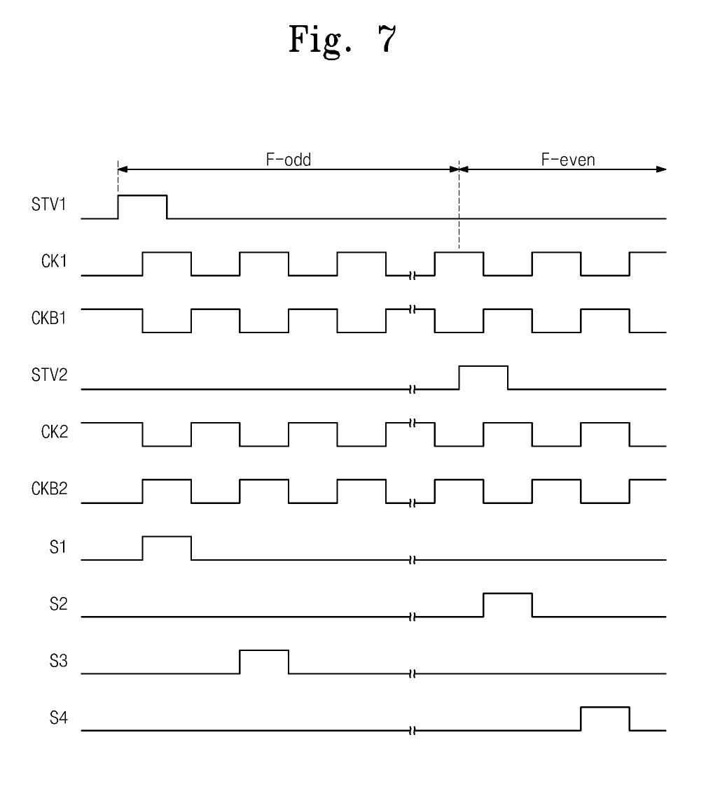

More detailed description of an operation of the exemplary embodiment of a sensor driver 123 of FIG. 5 will be described with reference to FIGS. 6 and 7.

FIG. 6 is a timing diagram showing the sensor driver 123 driven in the first scan mode, and FIG. 7 is a timing diagram showing the sensor driver 123 driven in the second scan mode.

Referring to FIG. 6, the sensor driver 123 is driven in a progressive scan method during the first scan mode. Thus, the sensor driver 123 receives the first start signal STV1 generated at a high logic state during one horizontal scan period, also referred to as “1H period” similar to that described above with respect to the previous exemplary embodiment, and the second start signal STV2 is delayed by the 1H period to be later than the first start signal STV1 from a timing controller 160 (shown in FIG. 1). This is different from the previous exemplary embodiment wherein the second start signal STV2 was delayed by only one half a horizontal scan period H/2 for reasons described in more detail below.

In addition, the first clock signal CK1 has a phase opposite to the second clock signal CK2, and the first clock bar signal CKB1 has a phase opposite to the second clock bar signal CKB2.

When the first start signal STV is generated, the first stage SRC1 outputs a first scan signal S1 to a first scan line SL1 during a high period of the first clock signal CK1. Then, when the second start signal STV2 is generated, the second stage SRC2 outputs a second scan signal S2 to a second scan line SL2 during a high period of the second clock signal CK2. Thus, the first scan signal S1 and the second scan signal S2 are not overlapped with each other, e.g., the second scan signal S2 begins when the first scan signal S1 ends.

A third stage SRC3 outputs a third scan signal S3 to a third scan line SL3 during the high period of the first clock signal CK1, and a fourth stage SRC4 outputs a fourth scan signal S4 to a fourth scan line SL4 during the high period of the second clock signal CK2. Therefore, the third scan signal S3 and the fourth scan signal S4 are not overlapped with each other. Thus, the odd numbered stages SRC1, SRC3, etc. output scan signals during a high period of the first clock signal CK1 and the even-numbered stages SRC2, SRC4, etc. output scan signals during a high period of the second clock signal CK2.

Although not shown in FIG. 6, the first dummy stage DSRC1 outputs a carry signal during a high period of the second clock bar signal CKB2 to apply the carry signal to an input terminal IN of the third stage SRC3. Also, the second dummy stage DSRC2 outputs the carry signal during the high period of the second clock bar signal CKB2 to apply the carry signal to an input terminal IN of the fourth stage SRC4.

Consequently, as shown in FIG. 6, in the first scan mode, the first to fourth scan signals S1˜S4 that are not overlapped with each other may be sequentially applied to the first to fourth scan lines SL1˜SL4. Remaining scan lines may be sequentially operated in a similar manner.

Referring to FIG. 7, in the second scan mode, the sensor driver 123 is driven in an interlace scan mode. Thus, the sensor driver 123 receives the first start signal STV1 and the second start signal STV2, wherein the second start signal STV2 is delayed by one frame period to be later than the first start signal STV1 from the timing controller 160.

In odd frames F-odd, when the first start signal STV1 is generated, the first stage SRC1 outputs the first scan signal S1 to the first scan line SL1 during the high period of the first clock signal CK1. Then, the third stage SRC3 outputs the third scan signal S3 to the third scan line SL3 during the high period of the first clock signal CK1. Although not shown in FIG. 7, remaining odd scan lines are sequentially operated during the odd frames F-odd in a similar manner.

The second start signal STV2 is generated when the odd frames F-odd are finished. Upon application of the second start signal STV2 even frames F-even start and the second stage SRC2 outputs the second scan signal S2 to the second scan line SL2 during the high period of the second clock signal CK2. Then, the fourth stage SRC4 outputs the fourth scan signal S4 to the fourth scan line SL4 during the high period of the second clock signal CK2. Although not shown in FIG. 7, remaining even scan lines are sequentially operated during the even frames F-even in a similar manner.

As described above, the sensor driver 123 may be driven either in the progressive scan method or the interlace scan method by controlling the high period of the first and second start signals STV1 and STV2. In the exemplary embodiment illustrated in FIGS. 5-7, the first and second start signals STV1 and STV2 may be separated by one horizontal scan period 1H or by one frame, e.g., one vertical scan period, in order to provide the different methods of operation.

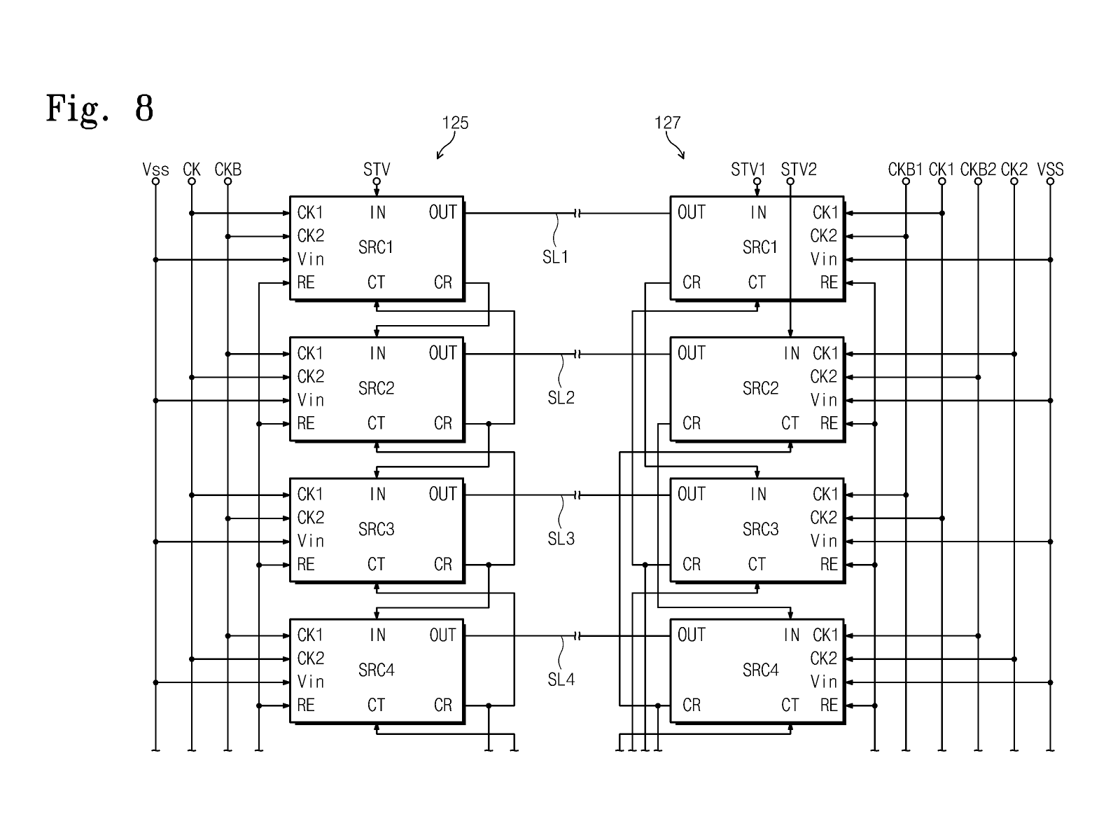

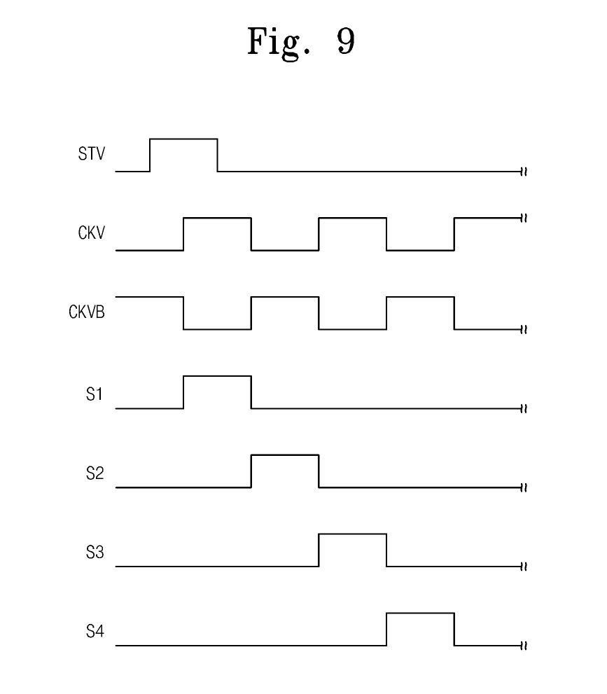

FIG. 8 is a block diagram showing another exemplary embodiment of a sensor driver according to the present invention, and FIG. 9 is a timing diagram showing a first sensor driver 125 of FIG. 8.

Referring to FIG. 8, a sensor driver may includes a first sensor driver 125 that is driven via a progressive scan method and a second sensor driver 127 that is driven via an interlace scan method.

The first sensor driver 125 has substantially the same circuit configuration and operating characteristics as those of the gate driver 140 shown in FIG. 1, e.g., that of a sequential shift register, and receives substantially the same signals, such as the vertical start signal STV, the vertical clock signal CK, the vertical clock bar signal CKB, and other similar signals.

As shown in FIG. 9, when the first sensor driver 125 starts its operation, a plurality of scan lines SL1˜SL4 may sequentially receive a scan signal.

Similarly, the second sensor driver 127 has substantially the same circuit configuration and function as those of the exemplary embodiment of a sensor driver 120 shown in FIG. 2. However, in the present exemplary embodiment, the second start signal STV2 is delayed by one frame period to be later than a first start signal STV1. Thus, when the second sensor driver 127 start its operation, odd stages, SRC1, SRC3, etc., and even stages, SRC2, SRC4, etc., are alternately operated in subsequent frames to output the scan signals as shown in FIG. 4. Thus, the sensor driver of the present exemplary embodiment may operate using both a progressive scan and interlaced scan method.

FIG. 10 is a top plan view showing the exemplary embodiment of a display apparatus of FIG. 1, and FIG. 11 is a cross-sectional view showing the exemplary embodiment of a display panel of FIG. 10.

Referring to FIGS. 10 and 11, the display panel 110 includes an array substrate 111, an opposite substrate 112 facing the array substrate 111, and a liquid crystal layer 113 disposed between the array substrate 111 and the opposite substrate 112.

The array substrate 111 includes a first base substrate 111a and a plurality of pixels 111b arranged on the first base substrate 111a. The opposite substrate 112 includes a second base substrate 112a and a plurality of sensors 112b arranged on the second base substrate 112a.

The display panel 110 may be divided into a display area DA for displaying an image thereon and a peripheral area PA surrounding the display area DA. In such an embodiment, the pixels 111b and the sensors 112b are arranged in the display area DA.

In the present exemplary embodiment, the gate driver 140 is arranged in the peripheral area PA of the first base substrate 111a through a thin film process, and the sensor driver 120 is arranged in the peripheral area PA of the second base substrate 112a through a thin film process, although alternative methods of forming the gate driver 140 and the sensor driver 120 may be used and alternative locations may be used for their placement. As shown in FIG. 11, the gate driver 140 and the sensor driver 120 are arranged inside the display panel 110 that is sealed along its periphery by a sealant 114.

As shown in FIG. 10, the array substrate 111 is partially overlapped with the opposite substrate 112. Thus, one end portion of the array substrate 111 does not face the opposite substrate 112, and one end portion of the opposite substrate 112 does not face the array substrate 111. Therefore, in one exemplary embodiment the data driver 150 may be mounted on one end portion of the array substrate 111 not corresponding to the opposite substrate 112 in a chip-on-glass type of application, and the read-out circuit 130 may be mounted on one end portion of the opposite substrate 112 not corresponding to the array substrate 111 in the chip-on-glass type of application. However, the data driver 150 and the read-out circuit may be arranged in a chip-on-film type arrangement or various other similar arrangements.

Although the exemplary embodiments of the present invention have been described above, it is understood that the present invention should not be limited to these exemplary embodiments but various changes and modifications can be made by one ordinary skilled in the art within the spirit and scope of the present invention as hereinafter claimed.

What is claimed is:

1. A display apparatus comprising:
a display panel which includes a plurality of pixels which receive a data signal to display an image;
a plurality of sensors disposed within the display panel, wherein the plurality of sensors sense an external signal from an exterior of the display apparatus and output a sensing signal corresponding to the external signal;
a data driver which provides the data signal to the plurality of pixels;
a gate driver which outputs a plurality of gate signals to the plurality of pixels; and
a sensor driver which includes a plurality of stages which output a plurality of sensor scan signals to the plurality of sensors,
wherein the sensor driver sequentially drives the plurality of stages in a first scan mode, and divides the plurality of stages into two groups of stages and alternately drives the two groups of stages in a second scan mode.

2. The display apparatus of claim 1, wherein a first stage of the plurality of stages starts an operation thereof in response to a first start signal, a second stage of the plurality of stages starts an operation thereof in response to a second start signal and the sensor driver drives the stages in either the first scan mode or the second scan mode in accordance with a timing of the first start signal and the second start signal.

3. The display apparatus of claim 2, wherein each of the plurality of sensor scan signals is maintained at a logic high state during one scan period, and the second start signal is delayed to be later than the first start signal by one half a scan period in the first scan mode.

4. The display apparatus of claim 3, wherein odd stages of the plurality of stages are connected to each other one after another, even stages of the plurality of stages are connected to each other one after another, a (4k-3)-th stage of the plurality of stages receives a first clock signal, a (4k-2)-th stage of the plurality of stages receives a second clock signal, a (4k-1)-th stage of the plurality of stages receives a first clock bar signal and a 4k-th stage of the plurality of stages receives a second clock bar signal, wherein k is an integer equal to or larger than 1.

5. The display apparatus of claim 4, wherein each of the first clock signal, the second clock signal, the first clock bar signal and the second clock bar signal has a high period corresponding in length to the scan period, the second clock signal is delayed to be later than the first clock signal by one half a scan period, the first clock bar signal has a phase substantially opposite to the first clock signal, and the second clock bar signal has a phase substantially opposite to the second clock signal.

6. The display apparatus of claim 2, wherein the sensor driver comprises a first group of stages including a plurality of odd stages connected to each other one after another among the plurality of stages and a second group of stages including a plurality of even stages connected to each other one after another among the plurality of stages, and the first group of stages and the second group of stages are alternately operated in subsequent frames during the second scan mode.

7. The display apparatus of claim 6, wherein the second start signal is delayed to be later than the first start signal by one frame period in the second scan mode.

8. The display apparatus of claim 7, wherein a (4k-3)-th stage of the plurality of stages receives a first clock signal, a (4k-2)-th stage of the plurality of stages receives a second clock signal, a (4k-1)-th stage of the plurality of stages receives a first clock bar signal and a 4k-th stage of the plurality of stages receives a second clock bar signal, where k is an integer equal to or larger than 1.

9. The display apparatus of claim 8, wherein each of the first clock signal, the second clock signal, the first clock bar signal and the second clock bar signal has a high period corresponding in length to the scan period, the first clock signal and the second clock signal have a same phase, and the first clock bar signal and the second clock bar signal have a same phase which is substantially opposite to the first clock signal.

10. The display apparatus of claim 2, wherein the sensor driver further comprises a plurality of dummy stages each of which is positioned between two adjacent stages of the plurality of stages.

11. The display apparatus of claim 10, wherein odd stages of the plurality of stages receive a first clock signal, even stages of the plurality of stages receive a second clock signal, odd dummy stages of the plurality of dummy stages receive a first clock bar signal, and even dummy stages of the plurality of dummy stages receive a second clock bar signal.

12. The display apparatus of claim 11, wherein each of the first clock signal, the second clock signal, the first clock bar signal and the second clock bar signal has a high period corresponding in length to the scan period, the first clock signal and the second clock signal have an opposite phase to each other, the first clock bar signal has an opposite phase to the first clock signal and the second clock bar signal has an opposite phase to the second clock signal.

13. The display apparatus of claim 11, wherein an output signal from a q-th dummy stage is provided to a (q+2)-th stage and an output signal from a q-th stage is provided to a q-th dummy stage, wherein q is an integer equal to or larger than 1.

14. The display apparatus of claim 2, further comprising a timing controller which controls the timing of the first start signal and the second start signal in response to a mode selection signal and provides the first start signal and the second start signal to the sensor driver.

15. The display apparatus of claim 1, wherein the display panel comprises an array substrate and an opposite substrate coupled with, and disposed substantially opposite to, the array substrate, the plurality of pixels are arranged on the array substrate, and the plurality of sensors are arranged on the opposite substrate.

16. The display apparatus of claim 15, wherein the gate driver and the sensor driver are directly disposed on the array substrate and the opposite substrate, respectively.

17. The display apparatus of claim 15, further comprising a read-out circuit disposed on the opposite substrate, wherein the read-out circuit receives the sensing signal from the plurality of sensors, and processes the sensing signal.

18. A display apparatus comprising:
a display panel comprising:
an array substrate on which a plurality of pixels which receive an image signal is arranged; and
an opposite substrate coupled with the array substrate;
a plurality of sensors disposed within the display panel, wherein the plurality of sensors sense an external signal and output a sensing signal corresponding to the external signal;
a data driver which provides the image signal to the plurality of pixels;
a gate driver which outputs a plurality of gate signals to the plurality of pixels;
a first sensor driver comprising a plurality of first stages which are operated in a first scan mode and sequentially output a plurality of first scan signals to the plurality of sensors; and
a second sensor driver comprising a plurality of second stages, wherein the plurality of second stages are divided into two groups which are alternately operated in a second scan mode, and wherein the plurality of second stages output a plurality of second scan signals through each of the two groups to the plurality of sensors.

19. The display apparatus of claim 18, wherein a first stage of the plurality of second stages starts an operation thereof in response to a first start signal, a second stage of the plurality of second stages starts an operation thereof in response to a second start signal, and the second start signal is delayed to be later than the first start signal by one frame period.

20. The display apparatus of claim 19, wherein a (4k-3)-th stage of the plurality of second stages receives a first clock signal, a (4k-2)-th stage of the plurality of second stages receives a second clock signal, a (4k-1)-th stage of the plurality of second stages receives a first clock bar signal, a 4k-th stage of the plurality of second stages receives a second clock bar signal, the first clock signal and the second clock signal have substantially a same phase, and the first clock bar signal and the second clock bar signal have a substantially same phase which is substantially opposite to the phase of the first clock signal.

21. A method of driving a sensor driver including a plurality of stages which output a plurality of sensor scan signals to a plurality of sensors, the method comprising:
sequentially driving the plurality of stages in a first scan mode;
dividing the plurality of stages into two groups of stages and alternately driving the two groups of the stages in a second scan mode.
